(19) United States
(12) Patent Application Publication
(10) Pub. No.: US 2012/0188491 A1
(43) Pub. Date: Jul. 26, 2012

(54) REFLECTIVE DISPLAY APPARATUS

(76) Inventor: NAKCHO CHOI, Hwaseong-si (KR)

(21) Appl. No.: 13/242,576

(22) Filed: Sep. 23, 2011

(30) Foreign Application Priority Data
Jan. 21, 2011 (KR) 10-2011-0006456

(51) Int. Cl. G02F 1/1335

(52) U.S. Cl. 349/97; 349/115

(57) ABSTRACT

A display apparatus includes a first substrate, a second substrate, and a cholesteric liquid crystal layer. The first substrate includes a first insulating substrate and pixel electrodes, and the second substrate includes a second insulating substrate facing the first substrate and a common electrode. The cholesteric liquid crystal layer reflects a first light of an external light and allows a second light to pass therethrough. An image formed by the first light is visible from a top surface of at least one of the first and second substrates. A light absorption layer is formed in a part of the remaining substrate opposite to one substrate representing the image.

### CROSS-REFERENCE TO RELATED APPLICATION

This application relies for priority upon Korean Patent Application No. 10-2011-0006456 filed on Jan. 21, 2011, the disclosure of which is hereby incorporated by reference herein in its entirety.

### BACKGROUND

1. Technical Field

The present disclosure relates to a reflective display apparatus. More particularly, the present disclosure relates to a reflective display apparatus including cholesteric liquid crystal.

2. Description of the Related Art

A liquid crystal display (LCD) may display images by controlling the alignment of liquid crystals having a dielectric anisotropy using an electric field generated due to potential difference between two opposite electrodes, and by adjusting light transmittance according to the alignment of liquid crystals.

In general, the LCD includes an LCD panel and a backlight unit provided at a rear of the LCD panel. Light generated from the backlight unit is incident into the LCD panel, so that the image is displayed on a front surface of the LCD panel. Since the backlight unit is provided at a rear of the LCD panel, the image may be disposed only on the front surface of the LCD panel

Recently, a reflective LCD using external light has been developed to reduce power consumption caused by the backlight unit. In addition, a dual type LCD has been developed to display the image on front and rear surfaces of the LCD.

### SUMMARY

Exemplary embodiments of the present invention provide a reflective display apparatus including cholesteric liquid crystal.

According to exemplary embodiments, a display apparatus includes a plurality of pixels, a first substrate, a second substrate, a cholesteric liquid crystal layer interposed between the first and second substrates, and a light absorption layer. The first substrate includes a first insulating substrate and a plurality of pixel electrodes disposed on the first insulating substrate corresponding to the pixels.

The second substrate includes a second insulating substrate opposite to the first substrate and a common electrode disposed on substantially an entire surface of the second insulating substrate to generate an electric field while interacting with each pixel electrode.

The cholesteric liquid crystal layer reflects a first light of an external light incident through at least one of the first and second substrates and allows a second light different from the first light to pass therethrough according to the electric field generated by the pixel electrodes and the common electrode. At least one light absorption layer is provided to absorb the second light.

The image formed by the first light is visible from a top surface of at least one of the first and second substrates. The remaining one of the first and second substrates s opposite to the first or second substrate having the image viewable from the top surface thereof includes at least one absorption region and at least one transmissive region, and the at least one light absorption layer is provided in the at least one absorption region of the pixels. The transmissive region may further include a transparent organic layer.

The first substrate includes first absorption regions and first transmissive regions, and the second substrate comprises second absorption regions and second transmissive regions. The light absorption layers include first light absorption layers provided in the absorption regions of the first substrate and second light absorption layers provided in the absorption regions of the second substrate. In this case, the first absorption regions correspond to the second transmissive regions in one-to-one correspondence, and the second absorption regions correspond to the first transmissive regions in one-to-one correspondence. In addition, the first light absorption layers may be spaced apart from the second light absorption layers when viewed in a plan view. In this case, a part of the transmissive region of the first substrate may overlap with a part of the transmissive region of the second substrate.

As described above, according to exemplary embodiments of the present invention having the above structure, the display apparatus includes a transmissive region in each pixel, so that the display apparatus may operate as the transmissive display apparatus. Since the display apparatus does not use a polarizing plate, the light transmittance can be increased.

In addition, since the display apparatus is manufactured by using the cholesteric liquid crystal having the characteristic of allowing specific light to pass therethrough, an additional light source is not necessary, so that the thickness and the power consumption of the display apparatus can be reduced and the structure of the display apparatus can be simplified.

According to exemplary embodiments, a display apparatus includes a first substrate including a first insulating substrate including a plurality of pixels and pixel electrodes fanned thereon, and each of pixels includes an absorption region, a transmissive region, a gate line, and a data line crossing the gate line and a thin film transistor connected to the gate line. The absorption region is formed over a whole area of each of the pixels except for the transmissive region and the transmittive region of one of the pixels crosses the transmissive region of an adjacent one of the pixels. The display apparatus further includes

a second insulating layer formed on the thin film transistor in each of the pixels, a light absorption layer formed on the second insulating layer and positioned corresponding to the absorption region in each of the pixels, a protective layer formed on the light absorption layer and underneath the pixel electrodes which are connected to a drain electrode of the thin film transistor in each of the pixels, a plurality of walls which surround each of the pixels and which overlap with the data line of each of the pixels in a first direction and overlap with the gate line of each of the pixels in a second direction opposite to the first direction, a cholesteric liquid crystal layer formed in an area defined between the first and second substrates by the walls in each of the pixels, and the cholesteric liquid crystal layer includes a levorotatory liquid crystal layer having levorotary liquid crystal molecules and a dextrorotatory liquid crystal layer having dextrorotatory liquid crystal molecules, and the levorotatory liquid crystal layer and the dextrorotatory liquid crystal layer are alternately aligned in a unit of row in area defined by the walls and a second substrate comprising a second insulating substrate opposite to the first substrate and a common electrode formed on substantially an entire surface of the second insulating substrate to generate an electric field while interacting with each pixel electrode. The display apparatus is adapted such that a first light passing through the cholesteric liquid crystal is absorbed in the light absorption layer provided in the absorption region in each of the pixels and a second light is reflected from the cholesteric liquid crystal layer, thereby providing an image which is visible from a top surface of the second substrate.

### BRIEF DESCRIPTION OF THE DRAWINGS

Exemplary embodiments of the present invention can be understood in more detail from the following detailed description when considered in conjunction with the accompanying drawings wherein:

FIG. 1 is a partially cut-away perspective view showing a display apparatus according to an exemplary embodiment of the present invention;

FIG. 2 is a plan view of a pixel shown in FIG. 1;

FIG. 3A is a sectional view taken along a line I-I′ of FIG. 2;

FIG. 3B is a sectional view taken along a line II-II′ of FIG. 2;

FIGS. 4 and 5 are sectional views showing an operation of a display apparatus according to an exemplary embodiment of the present invention;

FIG. 6 is a plan view showing a display apparatus according to an exemplary embodiment of the present invention;

FIG. 7 is a sectional view taken along a line III-III′ of FIG. 6;

FIG. 8 is a sectional view showing the operation of a display apparatus according to an exemplary embodiment of the present invention;

FIG. 9 is a plan view showing a display apparatus according to an exemplary embodiment of the present invention;

FIG. 10 is a sectional view taken along a line IV-IV′ of FIG. 9;

FIG. 11 is a sectional view showing an operation of a display apparatus according to an exemplary embodiment of the present invention;

FIG. 12 is a plan view showing a part of a display apparatus according to an exemplary embodiment of the present invention;

FIG. 13 is a plan view showing pixels and walls of a display apparatus according to an exemplary embodiment of the present invention;

FIG. 14 is a sectional view taken along a line IV-IV′ of FIG. 13;

FIG. 15 is a plan view showing a part of a display apparatus according to an exemplary embodiment of the present invention;

FIG. 16 is a perspective view showing the operation of a display apparatus according to an exemplary embodiment of the present invention;

FIG. 17 is a plan view showing a part of a display apparatus according to an exemplary embodiment of the present invention;

FIG. 18 is a plan view showing pixels and walls of a display apparatus according to an exemplary embodiment of the present invention; and

FIG. 19 is a sectional view taken along a line V-V′ of FIG. 18.

### DETAILED DESCRIPTION

The present invention can be modified in various forms and may not be limited to the following embodiments but include various applications and modifications. Therefore, the scope of the present invention should not be limited to the following embodiments.

When describing each attached drawing, similar reference numerals are designated as similar components.

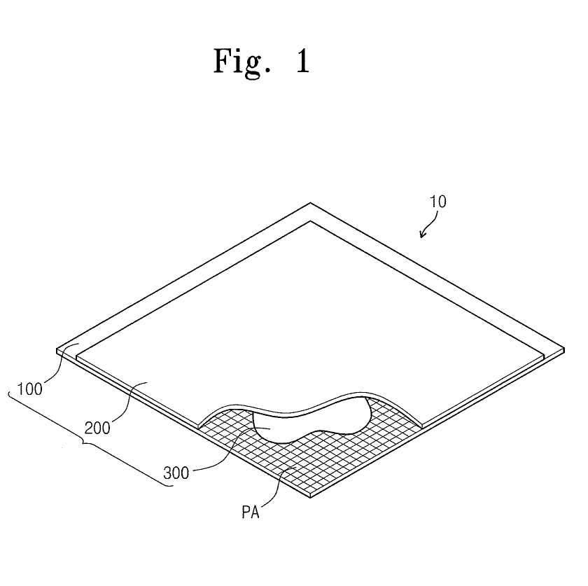

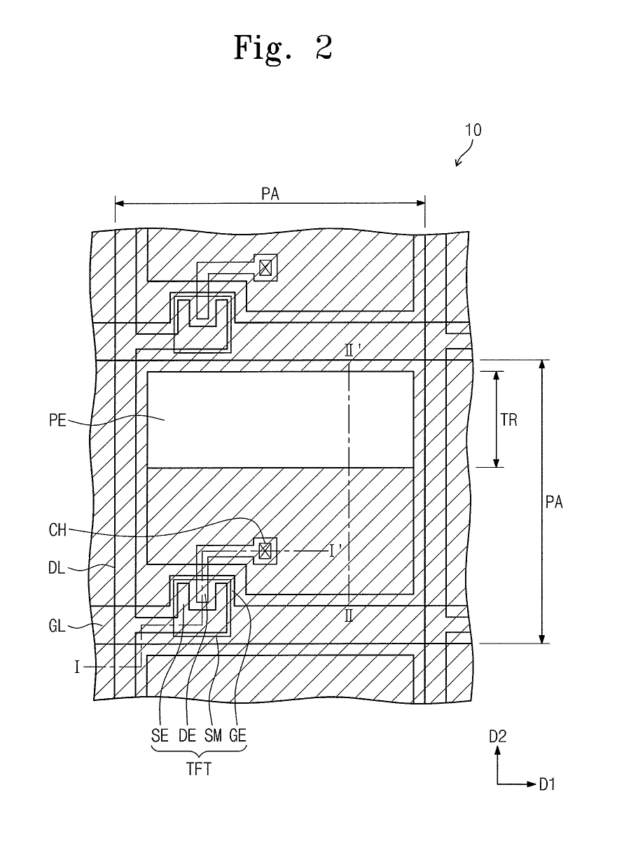

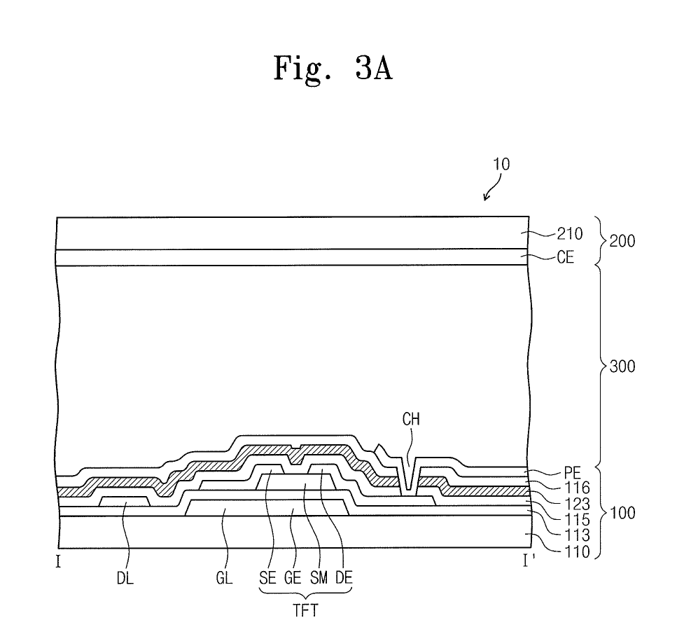

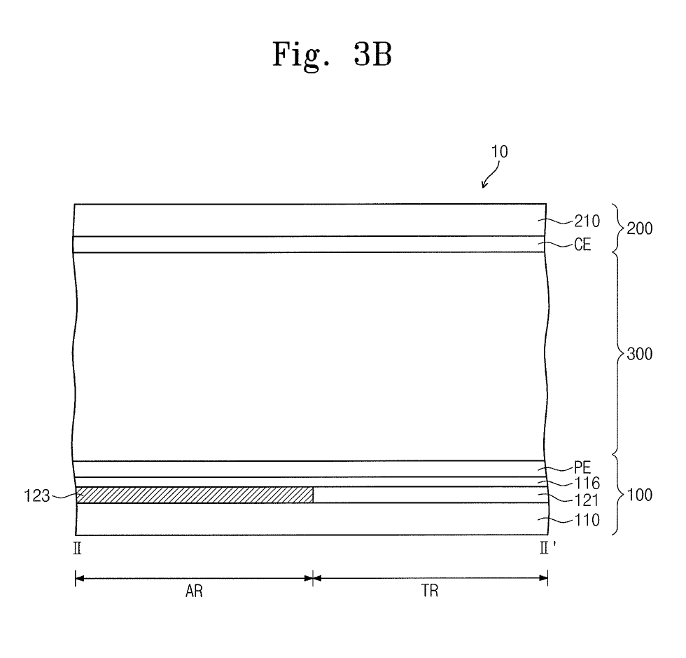

FIG. 1 is a partially-cut perspective view showing a display apparatus according to the first embodiment of the present invention, FIG. 2 is a plan view of a pixel shown in FIG. 1, FIG. 3A is a sectional view taken along line I-I′ of FIG. 2, and FIG. 3B is a sectional view taken along line II-II′ of FIG. 2.

Referring to FIGS. 1, 2 and 3A, the display apparatus 10 includes, for example, a first substrate 100, a second substrate 200 opposite to the first substrate 100 and a cholesteric liquid crystal layer 300 interposed between the first and second substrates 100 and 200.

The first substrate 100 includes a first insulating substrate 110 and a plurality of pixels PA. Since the pixels PA have the same structure, the following description will be made with respect to one pixel.

Referring to FIGS. 2, 3A and 3B, the pixel PA includes an absorption region AR and a transmissive region TR and is provided with a gate line GL, a data line DL, one thin film transistor TFT and pixel electrodes PE. The absorption region AR (hatched portion in FIG. 2) absorbs light incident into the absorption region AR and is formed over the whole area of the pixel PA except for the transmissive region TR.

The gate line GL extends in the first direction D1 and the data line DL extends in the second direction D2 crossing the first direction D1. The gate line GL is spaced apart from the data line DL while being electrically insulated from the data line DL by a first insulating layer 113 interposed between the gate line GL and the data line DL. It is noted that example embodiments of the present invention are not limited to the above-mentioned specific directions and positions for the gate line GL and the data line DL but rather the positions and specific directions for the gate line GL and the DL in the display apparatus may be varied in accordance with the present exemplary embodiment and exemplary embodiments described hereinafter as is understood by one skilled in the art.

The thin film transistor TFT is positioned adjacent to an intersection between the gate line GL and the data line DL and includes a gate electrode GE, a semiconductor layer SM, a source electrode SE, and a drain electrode DE. However, it is noted that the TFT may be disposed at other positions within the pixel PA in the present exemplary embodiment and in embodiments described hereinafter as is understood by one skilled in the art. Moreover, the number of gate lines GL and data lines DL may be varied in exemplary embodiments as understood by one skilled in the art.

The gate electrode GE branches from the gate line GL. The semiconductor layer SM overlaps with the gate electrode GE on the first insulating layer 113. The source electrode SE branches from the data line DL and overlaps with the semiconductor layer SM at a predetermined region. When viewed from the top, the drain electrode DE is spaced apart from the source electrode SE while interposing the semiconductor layer SM therebetween and overlaps with the semiconductor layer SM at a predetermined region. The semiconductor layer SM forms a conductive channel between the source electrode SE and the drain electrode DE.

A second insulating layer 115 is provided on the first insulating layer 113 formed with the source electrode SE and the drain electrode DE. The second insulating layer 115 is formed with a contact hole CH. A part of the drain electrode DE is exposed through the contact hole CH and the pixel electrode PE, which will be described later, is connected to the drain electrode DE through the contact hole CH.

A light absorption layer 123 and a transparent organic layer 121 are disposed on the second insulating layer 115. The light absorption layer 123 is disposed on the second insulating layer 115 corresponding to the absorption region AR to absorb the light passing through the cholesteric liquid crystal layer 300 and the light incident from a rear surface of the first substrate 100. The light absorption layer 123 may include, for example, an organic black matrix BM.

The transparent organic layer 121 is disposed on the second insulating layer 115 corresponding to the transmissive region TR and aligned on the same layer with the light absorption layer 123. The transparent organic layer 121 may be omitted.

A protective layer 116 is disposed on the light absorption layer 123 and the transparent organic layer 121 to protect the light absorption layer 123 and the transparent organic layer 121. The protective layer 116 includes a contact hole CH, which is positioned corresponding to the contact hole CH of the second insulating layer 115, to expose a part of the drain electrode DE.

The pixel electrode PE is disposed on the first insulating substrate 110 corresponding to the pixel PA in one-to-one correspondence. The pixel electrode PE is provided on the protective layer 116. The pixel electrode PE includes, for example, a transparent conductive material. The pixel electrode PE is electrically connected to the drain electrode DE through the contact hole CH formed through the second insulating layer 115 and the protective layer 116.

The second substrate 200 is opposite to the first substrate 100. The second substrate 200 includes a second insulating substrate 210 and a common electrode CE.

The common electrode CE is disposed on the entire surface of the second insulating substrate 210. A common voltage is applied to the common electrode CE and the common electrode CE forms the electric field in cooperation with the pixel electrode PE. The common electrode CE disposed on the second insulating substrate 210 may include, for example, a transparent material. Alternatively, for example, the first substrate 100 may instead include the common electrode 21 and the second substrate 200 may include pixels PA, pixel electrode PE, the protective layer 116, the absorption layer 123, the first insulating layer 113, the second insulating layer 115 and the transparent organic layer 121.

The cholesteric liquid crystal layer 300 is controlled by the electric field to adjust the quantity of light passing through or reflected from the cholesteric liquid crystal layer 300. Cholesteric liquid crystals can be formed by, for example, doping chiral dopant into basic liquid crystals having the nematic phase. For example, a predetermined amount of chiral dopant is added to the basic liquid crystals, the liquid crystal molecules having bar shapes are aligned as the layered structure, so that the cholesteric liquid crystals having the spiral structure can be formed. In addition, the spiral structure has the levorotatory or the dextrorotatory according to the characteristic of the chiral dopant and the liquid crystal molecules in each layer may have the property of the nematic liquid crystal molecules.

Liquid crystal molecules of the cholesteric liquid crystals may rotate, for example, in one direction in each layer so that the cholesteric liquid crystals may have the spiral structure. The interlayer distance of the cholesteric liquid crystal layer 300 can be adjusted by, for example, controlling the amount of the chiral dopant, so that the interlayer reflectivity of the cholesteric liquid crystals can be adjusted. Thus, upon receiving the external light, the cholesteric liquid crystal layer 300 can selectively reflect the light having a specific wavelength and the inherent color of the light is visible to the user.

The cholesteric liquid crystal layer 300 may have, for example, one of a planar state and a homeotropic state. If the electric field is not applied to the cholesteric liquid crystals, long axes of the bar-shape liquid crystal molecules in each layer may be aligned in parallel to each other in the horizontal direction of the first and second substrates 100 and 200, which is the planar state. In the planar state, the cholesteric liquid crystal layer 300 reflects the light having the specific wavelength. In contrast, if the electric field is applied to the cholesteric liquid crystals, long axes of the bar-shape liquid crystal molecules in each layer may be aligned in parallel to each other in the vertical direction of the first and second substrates 100 and 200, which is the homeotropic state. In the homeotropic state, the external light may pass through the cholesteric liquid crystal layer 300. Thus, the display apparatus 10 applies the electric field to the cholesteric liquid crystal layer 300 and changes the state of the cholesteric liquid crystal layer 300 to display the image by adjusting the quantity of the light passing through or reflected from the cholesteric liquid crystal layer 300.

Hereinafter, the operation of the display apparatus 10 will be described. The cholesteric liquid crystal layer 300 reflects the light having the specific wavelength according to, for example, the physical characteristics (for instance, pitch) of the cholesteric liquid crystals and allows the remaining light to pass therethrough. For the purpose of convenience of explanation, the light having the specific wavelength reflected by the cholesteric liquid crystal layer 300 will be referred to as a first light and the remaining light will be referred to as a second light.

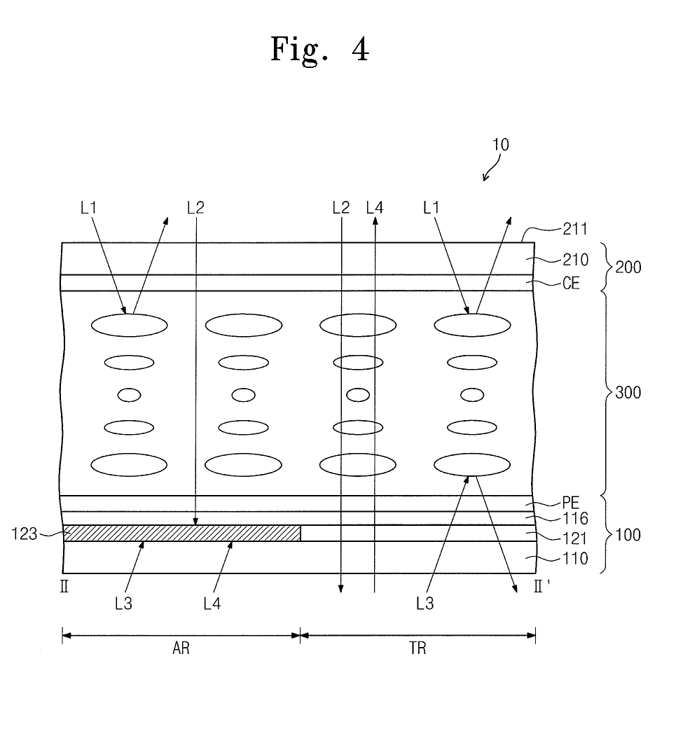

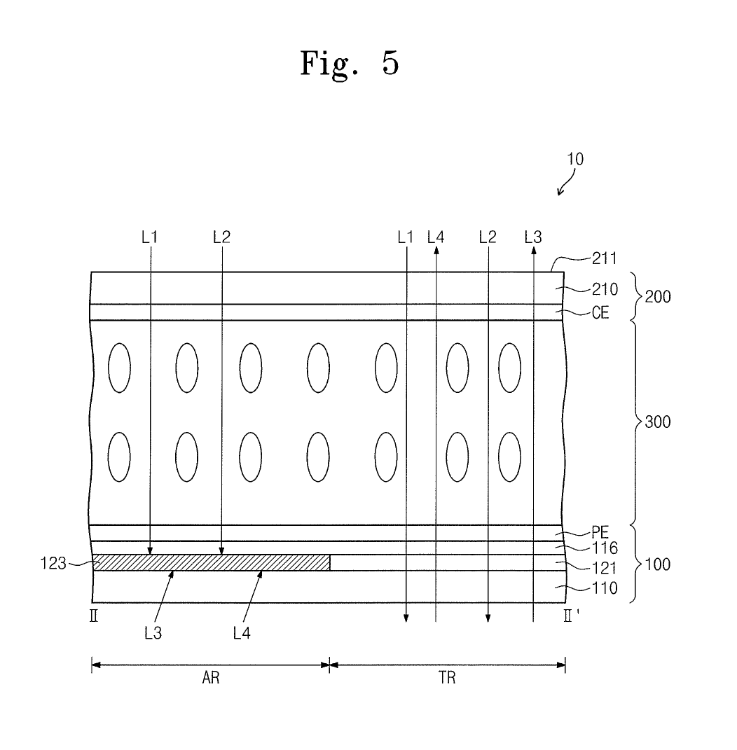

FIGS. 4 and 5 are sectional views showing the operation of the display apparatus 10 according to the first embodiment of the present invention, in which FIG. 4 shows the planar state of the cholesteric liquid crystal layer 300.

Referring to FIG. 4, the first light L1 incident into the second substrate 200 from the outside is reflected by the cholesteric liquid crystal layer 300 and the second light L2 passes through the cholesteric liquid crystal layer 300. A part of the second light L2 is absorbed in the light absorption layer 123 formed in the absorption region AR.

Thus, the first light L1 travels toward the top surface 211 of the second substrate 200. As a result, the inherent color of the first light L1 is visible to the user, so that the user may recognize the image created by the first light L1 from the top surface 211 of the second substrate 200.

In contrast, third and fourth lights L3 and L4 incident into the absorption region AR through the first substrate 100 are absorbed in the light absorption layer 123.

Although the third light L3 incident through the transmissive region TR is reflected, the fourth light L4 incident through the transmissive region TR passes through the second substrate 200, so the user can recognize the object located at a rear of the first substrate 100 due to the fourth light L4, which is incident through the first substrate 100 and passes through the second substrate 200.

FIG. 5 is a sectional view showing the operation of the display apparatus 10 when the cholesteric liquid crystal layer 300 is in the homeotropic state.

Referring to FIG. 5, the first and second lights L1 and L2 incident through the second substrate 200 from the outside pass through the cholesteric liquid crystal layer 300. The first and second lights L1 and L2 that have passed through the cholesteric liquid crystal layer 300 are absorbed in the light absorption layer 123.

Therefore, there is no light passing through the second substrate 200 corresponding to the absorption region AR, so a black color is visible from the front surface or top surface 211 of the second substrate 200. The operation of the display apparatus 10 in the transmissive region TR is substantially similar to the operation of the display apparatus 10 shown in FIG. 4, so detailed description thereof will be omitted.

As described above, the display apparatus 10 can provide the image formed by the first light L1 and the user can recognize the object located at the rear of the first substrate 100 due to the fourth light L4, which is incident through the first substrate 100 and passes through the second substrate 200. Thus, the display apparatus 10 according to the first embodiment is a transparent reflective display apparatus.

The display apparatus 10 is an active matrix display apparatus including the thin film transistor TFT, but exemplary embodiments of the present invention are not limited thereto. For instance, the display apparatus 10 may be a passive matrix display apparatus having no switching device.

The display apparatus 10 having the above structure is the reflective display apparatus that provides the image using the external light, so an additional light source is not required. Thus, the power consumption and the thickness of the display apparatus 10 can be reduced. In addition, the display apparatus 10 reflects the light having the specific wavelength by the cholesteric liquid crystals, so an additional polarizing plate is not required. Thus, reduction of the light transmittance caused by the polarizing plate can be prevented.

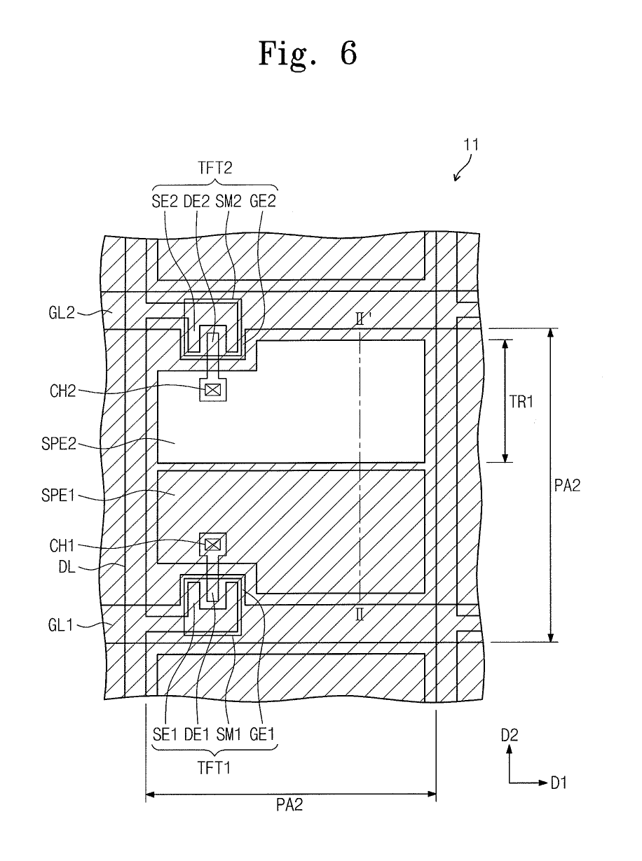

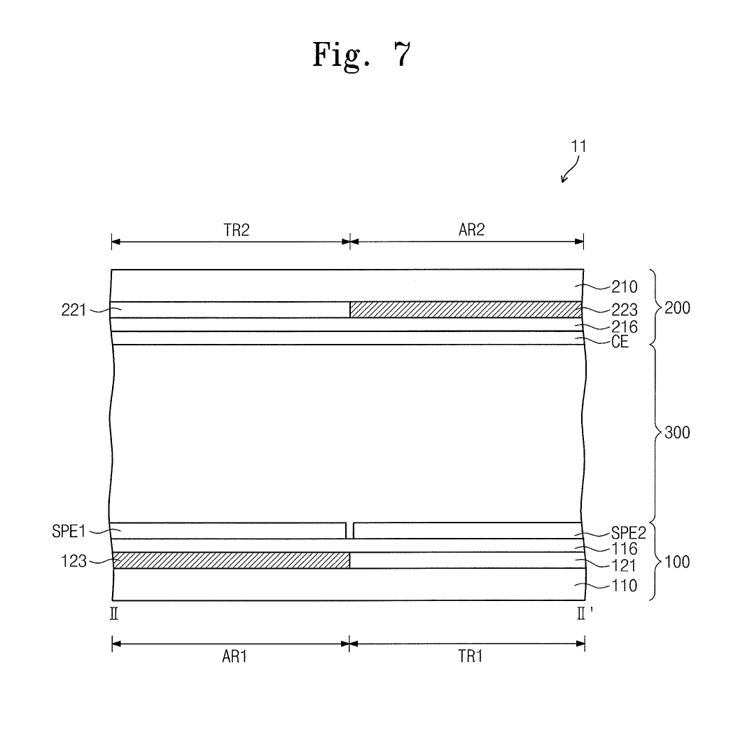

FIG. 6 is a plan view showing a display apparatus 11 according to the second embodiment of the present invention and FIG. 7 is a sectional view taken along line III-III′ of FIG. 6. The following description of the second embodiment of the present invention will be made while focusing on the difference with respect to the first embodiment in order to avoid redundancy. In addition, the elements and structures, which are not specifically described in the following embodiments, may be identical to those of the first embodiment. Further, the same reference numerals will be used to refer to the same elements throughout the drawings.

Similar to the display apparatus 10 according to the first embodiment, the display apparatus 11 according to the second embodiment includes a plurality of pixels PA2. Since the pixels PA2 have the same structure, the following description will be made with respect to one pixel PA2.

Referring to FIGS. 6 and 7, the pixel PA2 includes, for example, first and second gate lines GL1 and GL2, a data line DL, first and second thin film transistors TFT1 and TFT2, a first light absorption layer 123, a first transparent organic layer 121 and a pixel electrode. In addition, the first substrate 100 includes a first absorption region AR1 and a first transmissive region TR1, and the second substrate 200 includes a second absorption region AR2 and a second transmissive region TR2. The first absorption region AR1 corresponds to the second transmissive region TR2, and the second absorption region AR2 corresponds to the first transmissive region TR1. In the pixel PA2, the first absorption region (hatched portion in FIG. 6) AR1 absorbs the light incident into the first absorption region AR1, and is formed over the whole area of the pixel PA2 except for the first transmissive region TR1. Although not shown in FIG. 6, the second absorption region AR2 absorbs the light incident into the second absorption region AR2, and is formed over the whole area of the pixel PA2 except for the second transmittive region TR1.

The first and second gate lines GL1 and GL2 extend in the first direction D1 and the data line DL extends in the second direction D2 while crossing the first and second gate lines GL1 and GL2. It is noted that example embodiments of the present invention are not limited to the above-mentioned specific directions and positions for the gate lines GL1 and GL2 and the data line DL but rather the positions and for the gate lines GL1 and GL2 and the data line DL in the display apparatus may be varied in accordance with example embodiments of the present invention as is understood by one skilled in the art. The first and second gate lines GL1 and GL2 are electrically insulated from the data line DL by a gate insulating layer interposed between the first and second gate lines GL1 and GL2 and the data line DL in similar fashion as the gate line GL is electrically insulated from the data line DL by the gate insulating layer 113 in the first embodiment depicted in FIG. 3A.

The first thin film transistor TFT1 is positioned adjacent to an intersection between the first gate line GL1 and the data line DL and includes a first gate electrode GE1, a first semiconductor layer SM1, a first source electrode SE1 and a first drain electrode DE1. The second thin film transistor TFT2 is positioned adjacent to an intersection between the second gate line GL2 and the data line DL and includes a second gate electrode GE2, a second semiconductor layer SM2, a second source electrode SE2 and a second drain electrode DE2. The interlayer structure of the first and second thin film transistors TFT1 and TFT2 are substantially the same as the interlayer structure of the transistor TFT shown in FIG. 3A.

A second insulating layer is provided on the first and second transistors TFT1 and TFT2 in similar fashion as the second insulating layer 115 is disposed on the TFT the the first embodiment depicted in FIG. 3A. The second insulating layer is formed with a first contact hole CH1 to expose a part of the first drain electrode DE1 and a second contact hole CH2 to expose a part of the second drain electrode DE2. A first sub-pixel electrode SPE1, which will be described later, is connected to the first drain electrode DE1 through the first contact hole CH1 and a second sub-pixel electrode SPE2, which will be described later, is connected to the second drain electrode DE2 through the second contact hole CH2.

The first transparent organic layer 121 is disposed on the second insulating layer corresponding to the first transmittive region TR1 and the first light absorption layer 123 is disposed on the second insulating layer corresponding to the first absorption region AR1. A protective layer 116 is disposed on the first light absorption layer 123. Similar to the second insulating layer, the protective layer 116 is formed with contact holes which are positioned corresponding to the first and second contact holes CH1 and CH2 to expose a part of the first and second drain electrodes DE1 and DE2. Alternatively, the first transparent organic layer may be omitted.

The pixel electrode is divided into, for example, the first and second sub-pixels SPE1 and SPE2 and disposed on the protective layer 116. The first sub-pixel SPE1 is positioned corresponding to the first absorption region AR1 and the second sub-pixel SPE2 is positioned corresponding to the first transmittive region TR1. The first and second sub-pixels SPE1 and SPE2 are spaced apart from each other. The first and second sub-pixels SPE1 and SPE2 may include, for example, a transparent conductive material.

The first sub-pixel SPE1 is electrically connected to the first drain electrode DE1 through the first contact hole CH1 and the second sub-pixel SPE2 is electrically connected to the second drain electrode DE2 through the second contact hole CH2.

The second substrate 200 includes, for example, a second insulating substrate 210, a common electrode CE, a second light absorption layer 223 and a second transparent organic layer 221. The second light absorption layer 223 is disposed on the second insulating substrate 210 corresponding to the second absorption region AR2 and the second transparent organic layer 221 is disposed on the second insulating substrate 210 corresponding to the second transmissive region TR2.

In addition, a second protective layer 216 is provided on the second light absorption layer 223 and the second transparent organic layer 221 to protect the second light absorption layer 223 and the second transparent organic layer 221 and the common electrode CE is formed on the second protective layer 216. It is further noted that the second transparent organic layer 221 may be omitted.

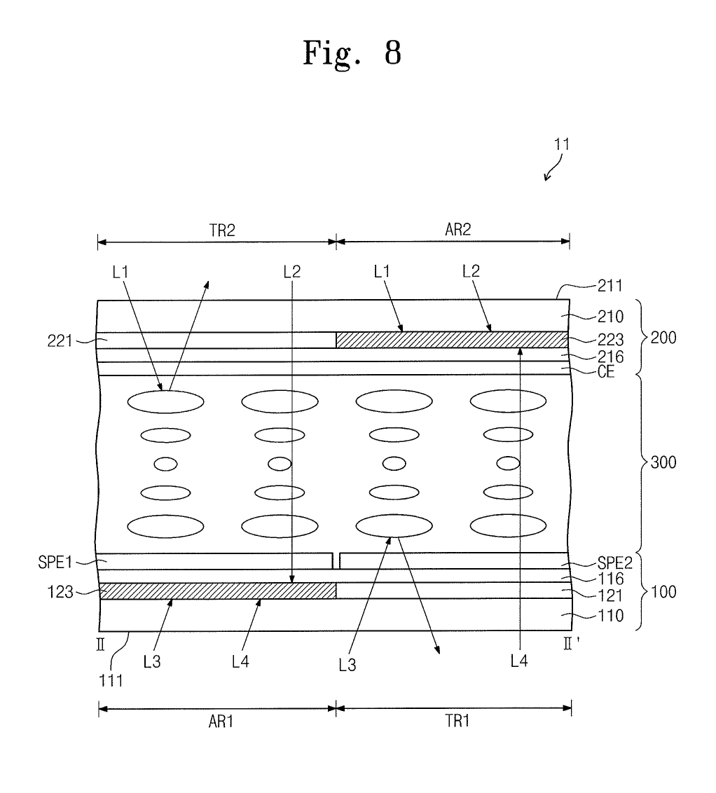

FIG. 8 is a sectional view showing the operation of the display apparatus according to the second embodiment of the present invention. The operation of the display apparatus 10 according to the first embodiment is substantially the same as the operation of the display apparatus 11 according to the second embodiment when the cholesteric liquid crystal layer 300 is in the homeotropic state. Thus, the following description will be focused on the operation of the display apparatus when the cholesteric liquid crystal layer 300 is in the planar state.

Referring to FIG. 8, the third and fourth lights L3 and L4 incident into the first absorption region AR1 through the first substrate 100 and the second light L2 incident into the first absorption region AR1 through the second substrate 200 are absorbed in the first light absorption layer 123. In addition, the light incident into the second absorption region AR2 from among the fourth lights L4 incident through the first transmissive region TR1 is absorbed in the second light absorption layer 223.

Thus, the image generated by the third light L3, which is incident through the first transmittive region TR1 of the first substrate 100, may be visible from the front surface or top surface 111 of the first substrate 100.

Similarly, the first and second lights L1 and L2 incident into the second absorption region AR2 through the second substrate 200 and the fourth light L4 incident into the second absorption region AR2 through the first substrate 100 are absorbed in the second light absorption layer 223. In addition, the light incident into the first absorption region AR1 from among the second lights L2 incident through the second transmissive region TR2 is absorbed in the first light absorption layer 123. Thus, the image generated by the first light L1, which is incident through the second transmissive region TR2 of the second substrate 200, may be visible from the front surface or top surface 211 of the second substrate 200, so that the user may recognize the image generated by the first light L1.

As described above, the display apparatus 11 according to the second embodiment can be operated as a dual type reflective display apparatus capable of displaying images on the first and second substrates 100 and 200. The first and second sub-pixel electrodes SPE1 and SPE2 are individually controlled by the first and second thin film transistors TFT1 and TFT2, respectively, so that the display apparatus 11 can display different images on the first and second substrates 100 and 200.

Since the display apparatus 11 having the above structure is the reflective display apparatus that provides the image using the external light, an additional light source is not required. Thus, the power consumption and the thickness of the display apparatus 11 can be reduced. In addition, the display apparatus 11 reflects the light having the specific wavelength by the cholesteric liquid crystals, so an additional polarizing plate is not required. Thus, reduction of the light transmittance caused by the polarizing plate can be prevented. Further, the display apparatus 11 has a relatively simple structure, so the display apparatus can be manufactured in mass production.

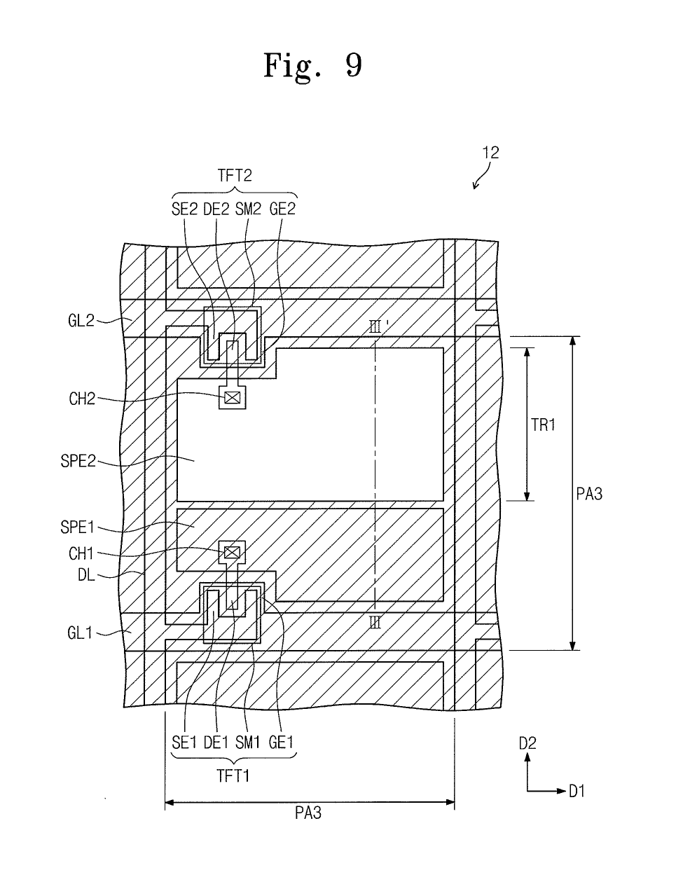

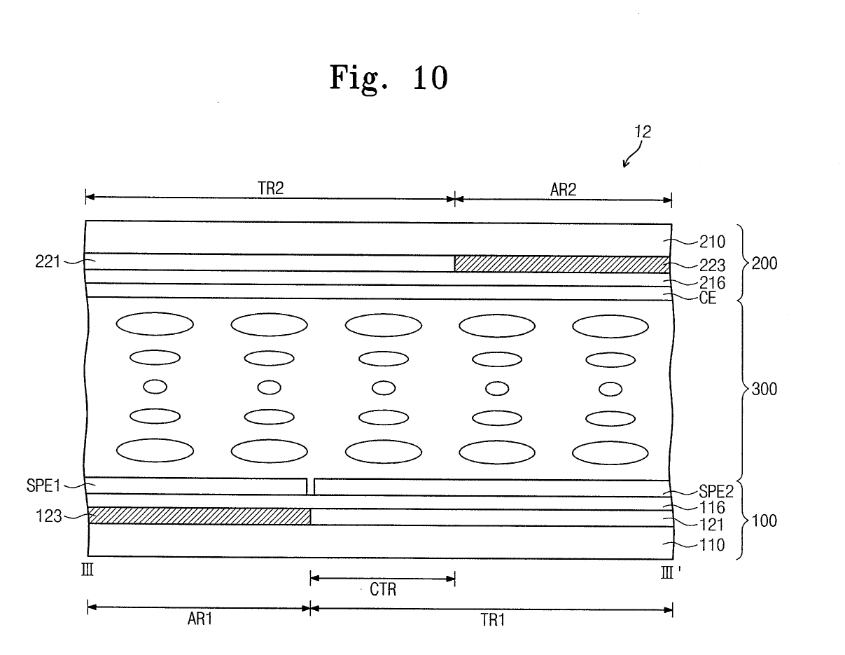

FIG. 9 is a plan view showing a display apparatus 12 according to the third embodiment of the present invention and FIG. 10 is a sectional view taken along line IV-IV′ of FIG. 9. In the following description of the third embodiment, the same reference numerals will be assigned to the elements and structures, which are substantially the same as or identical to those of the first and second embodiments, and the detailed description thereof will be omitted in order to avoid redundancy.

Similar to the display apparatus 10 of the first embodiment, the display apparatus 12 according to the third embodiment includes a plurality of pixels PA3. Since the pixels PA3 have the same structure, the following description will be made with respect to one pixel PA3.

Referring to FIGS. 9 and 10, the pixel PA3 includes, for example, first and second gate lines GL1 and GL2, a data line DL, first and second thin film transistors TFT1 and TFT2, a first light absorption layer 123, a first transparent organic layer 121 and a pixel electrode. The structure of the pixel PA3 is substantially the same as the structure of the pixel PA2 shown in FIGS. 6 and 7, so the same reference numerals will be assigned to the same elements and the detailed description thereof will be omitted.

The first substrate 100 includes, for example, a first absorption region AR1 and a first transmissive region TR1, and the second substrate 200 includes, for example, a second absorption region AR2 and a second transmissive region TR2.

The first light absorption layer 123 is disposed on the first insulating substrate 110 corresponding to the first absorption region AR1, and the second light absorption layer 223 is disposed on the second insulating substrate 210 corresponding to the second absorption region AR2. When viewed from the top, the first light absorption layer 123 is spaced apart from the second light absorption layer 223. Thus, a common transmissive region CTR where the first transmissive region TR1 of the first substrate 100 overlaps with the second transmissive region TR2 of the second substrate 200 can be formed.

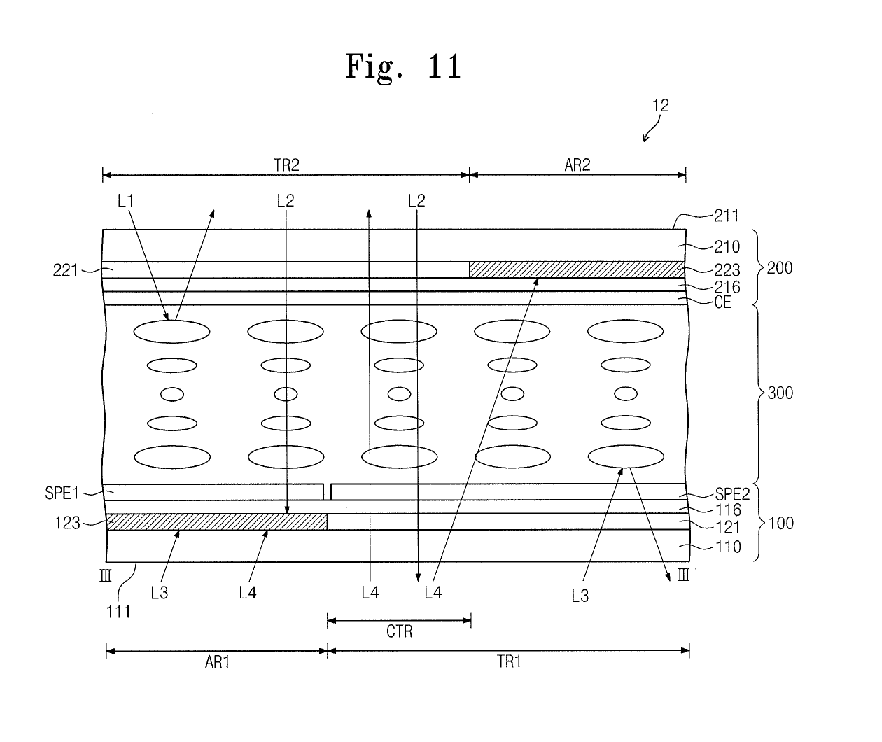

FIG. 11 is a sectional view showing the operation of the display apparatus according to the third embodiment of the present invention. The operation of the display apparatus 12 according to the third embodiment is substantially the same as the operation of the display apparatus 10 according to the first embodiment when the cholesteric liquid crystal layer 300 is in the homeotropic state. Thus, the following description will be focused on the operation of the display apparatus when the cholesteric liquid crystal layer 300 is in the planar state.

Referring to FIG. 11, similar to the second embodiment, the third and fourth lights L3 and L4 incident into the first absorption region AR1 through the first substrate 100 and the second light L2 incident into the first absorption region AR1 through the second transmissive region TR2 are absorbed in the first light absorption layer 123. Thus, the image generated by the third light L3, which is incident into the first transmissive region TR1, may be visible from the front surface or top surface 111 of the first substrate 100.

In addition, the object located at the rear of the second substrate 200 may be visible due to the second light L2, which is incident through the second transmissive region TR2 and passes through the first transmissive region TR1.

Meanwhile, among the first and second lights L1 and L2 incident into the second absorption region AR2 from the rear surface of the second substrate 200 and the fourth light L4 incident into the second absorption region AR2 through the first transmissive region TR1, the light incident into the second absorption region AR2 is absorbed in the first light absorption layer 123. Thus, the image generated by the first light L1, which is incident through the second transmissive region TR2, may be visible from the first substrate 100.

In addition, the object located at the rear of the first substrate 100 may be visible due to the fourth light L4, which is incident through the first transmissive region TR1 and passes through the second transmissive region TR2.

As described above, according to the display apparatus 12 of the third embodiment, the user can view the images from the front surfaces or top surfaces 111, 211 of the first and second substrates 100 and 200 and can recognize the object located at the rear of the first and second substrates 100 and 200. That is, the display apparatus 12 of the third embodiment is a dual type transparent reflective display apparatus.

Similar to the second embodiment, the first and second sub-pixel electrodes SPE1 and SPE2 according to the third embodiment are individually controlled by the first and second thin film transistors TFT1 and TFT2, respectively, so the display apparatus 12 can display different images on the first and second substrates 100 and 200.

Since the display apparatus 12 having the above structure is the reflective display apparatus that provides the image using the external light, an additional light source is not required. Thus, the power consumption and the thickness of the display apparatus 12 can be reduced. In addition, the display apparatus 12 reflects the light having the specific wavelength by the cholesteric liquid crystals, so an additional polarizing plate is not required. Thus, reduction of the light transmittance caused by the polarizing plate can be prevented. Further, the display apparatus 12 has the simple structure, so the display apparatus 12 can be manufactured in mass production.

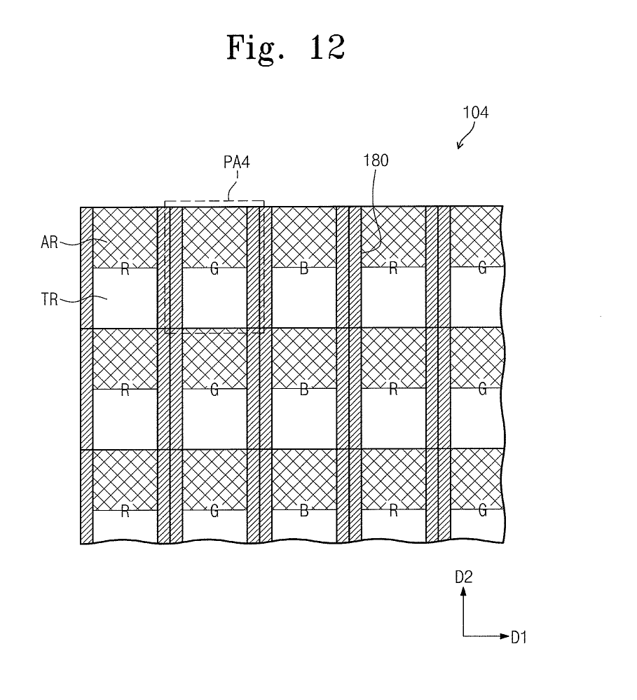

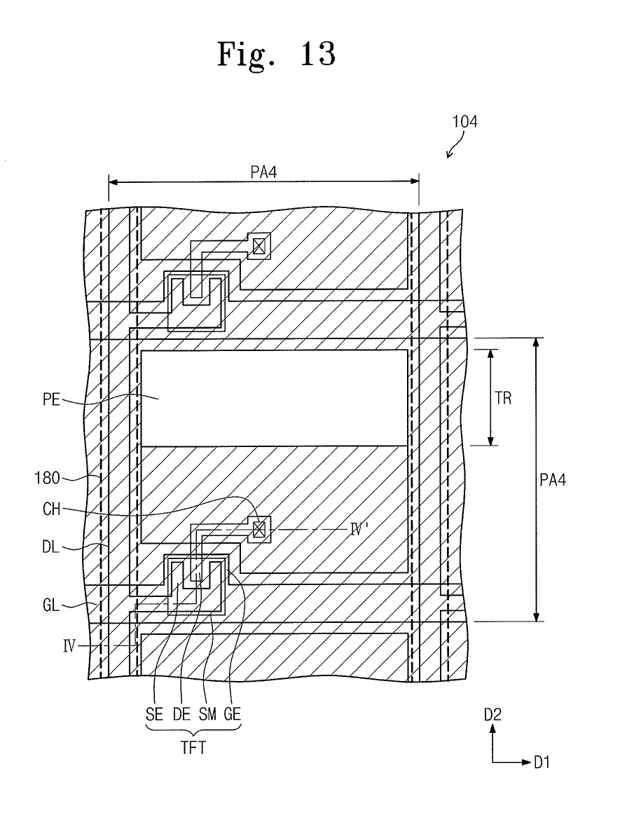

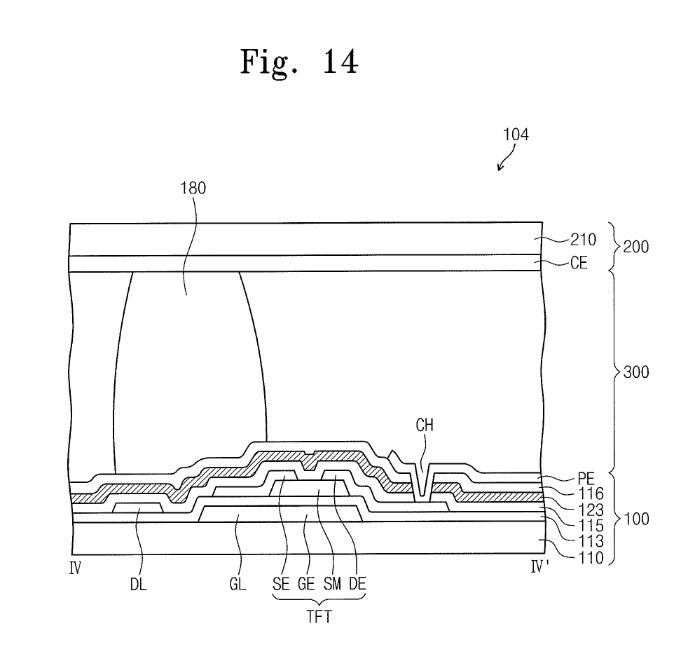

FIG. 12 is a plan view showing a part of a display apparatus 104 according to a fourth embodiment of the present invention, FIG. 13 is a plan view showing pixels PA4 and walls 180 of the display apparatus 104 according to the fourth embodiment of the present invention, and FIG. 14 is a sectional view taken along line IV-IV′ of FIG. 13.

Referring to FIGS. 12 to 14, a first substrate 100 includes pixels PA4. Since the pixels PA4 have the same structure, the following description will be made with respect to one pixel PA4.

The pixel PA4 includes an absorption region AR and a transmissive region TR. The absorption region AR is formed over the whole area of the pixel PA4 except for the transmissive region TR. The transmissive regions TR of the pixels PA4 are aligned in series.

The pixel PA4 includes, for example, a gate line GL, a data line DL, and a thin film transistor TFT. The gate line GL and the thin film transistor TFT are substantially the same as the gate line GL and the thin film transistor TFT shown in FIGS. 2 and 3, so the same reference numerals are assigned thereto and the detailed description thereof will be omitted in order to avoid redundancy.

A second insulating layer 115 is disposed on the thin film transistor TFT and a light absorption layer 123 and a transparent organic layer 121 are disposed on the second insulating layer 115 in a similar fashion as in the first embodiment depicted in 3A and 3B. The transparent organic layer 121 is positioned corresponding to the transmittive region TR and the light absorption layer 123 is positioned corresponding to the absorption region AR. In this embodiment the transparent organic layer 121 may be omitted.

A protective layer 116 is disposed on the light absorption layer 123 and the transparent organic layer 121 and a pixel electrode PE is disposed on the protective layer 116. The pixel electrode PE is connected to a drain electrode DE of the thin film transistor TFT through the contact hole CH.

The walls 180 are provided on the first substrate 100. In detail, the walls 180 are disposed on the protective layer 116.

The walls 180 may overlap with the data line DL. For instance, the walls 180 may have a width larger than a width of the data line DL. A contact area of the walls 180 with respect to other elements may vary depending on the pixel design and the process margin. The walls 180 are aligned at an edge of each pixel PA4. The walls 180 extend in the second direction D2 and are aligned in the first direction D1.

The cholesteric liquid crystal layer 300 may include, for example, a red cholesteric liquid crystal layer, a green cholesteric liquid crystal layer and a blue cholesteric liquid crystal layer. The red cholesteric liquid crystal layer, the green cholesteric liquid crystal layer and the blue cholesteric liquid crystal layer are provided on the regions defined by the walls. Thus, each pixel PA3 may represent, for example, one of red, green and blue colors. The red cholesteric liquid crystal layer, the green cholesteric liquid crystal layer or the blue cholesteric liquid crystal layer can be filled, for example, in a plurality of pixels PA4 at a time instead of being individually filled in each pixel PA4. The cholesteric liquid crystal layer 300 can be filled through, for example, an inkjet scheme or a filling scheme.

The second substrate 200 includes a second insulating substrate 210 and a common electrode CE. The common electrode CE is disposed on the second insulating substrate 210.

The operation of the display apparatus 104 according to the fourth embodiment is similar to the operation of the display apparatus 10 according to the first embodiment. For example, as the external light is incident into the second substrate 200, the cholesteric liquid crystal layer 300 reflects the light having the red, green and blue wavelengths according to the property of the liquid crystals provided in each pixel PA4 and allows the light having the wavelength other than the red, green and blue wavelengths to pass therethrough. A part of the light passing through the cholesteric liquid crystal layer 300 is absorbed in the light absorption layer 123 provided in the absorption region AR. Thus, the image is visible from the second substrate 200 due to the lights reflected by the cholesteric liquid crystal layer 300. For example, since the cholesteric liquid crystal layer 300 reflects the red, green or blue light, the color image may be visible from the second substrate 200. Therefore, the cholesteric liquid crystal layer 300 represents the red, green or blue color, so an additional color filter used to represent the color image may not be necessary.

Although the light incident into the absorption region AR through the first substrate 100 is absorbed in the light absorption layer 123, the light, which is incident into the transmissive region TR and passes through the cholesteric liquid crystal layer 300, may pass through the second substrate 200, so the user can recognize the object located at the rear of the first substrate 100 due to the light passing through the second substrate 200. Thus, the display apparatus may serve as, for example, a color transparent reflective display apparatus.

Since the display apparatus is the reflective display apparatus, the walls 180 may have a white color capable of reflecting the external light at higher reflectivity. In addition, an interconnection part of the data line DL can be covered with the walls 180 even if an additional black matrix is not provided in the display apparatus 104. Further, since the walls 180 have the white color, the brightness of the display apparatus 104 can be increased.

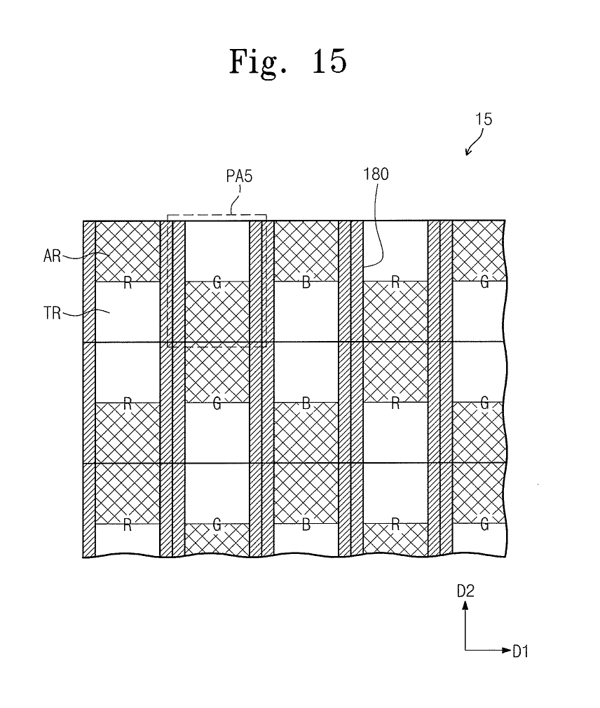

FIG. 15 is a plan view showing a part of a display apparatus 15 according to the fifth embodiment of the present invention. Referring to FIG. 15, a first substrate 100 includes a plurality of pixels PA5 and each pixel PA5 includes an absorption region AR and a transmissive region TR. The absorption region AR (hatched portion) absorbs the light incident into the absorption region AR and is formed over the whole area of the pixel PA5 except for the transmissive region TR.

If the transmissive regions TR are aligned in series, the diffraction patterns may occur due to the destructive interference and constructive interference between adjacent transmittive regions, so that the display quality is degraded. However, according to the above arrangement, the second lights passing through the cholesteric liquid crystal layer 300 may be emitted at a position different from the position of the adjacent pixel, so that the diffraction patterns may be reduced.

The structure of the pixel PA5 according to the fifth embodiment of the present invention is substantially the same as the structure of the pixel according to the fourth embodiment of the present invention shown in FIGS. 13 and 14, so the detailed description thereof will be omitted.

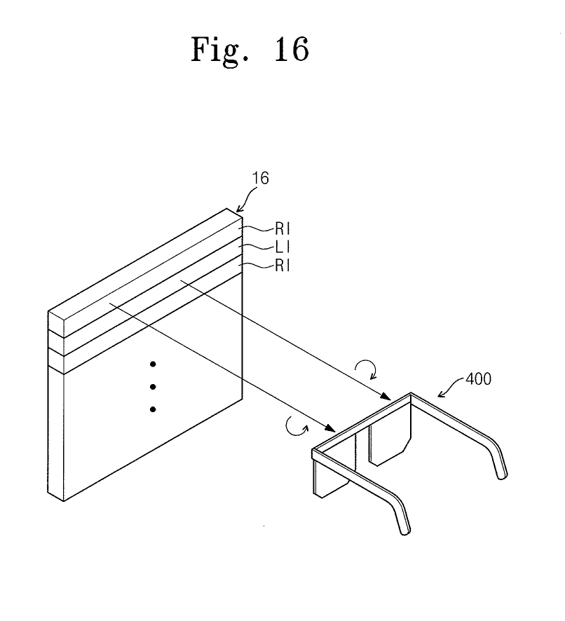

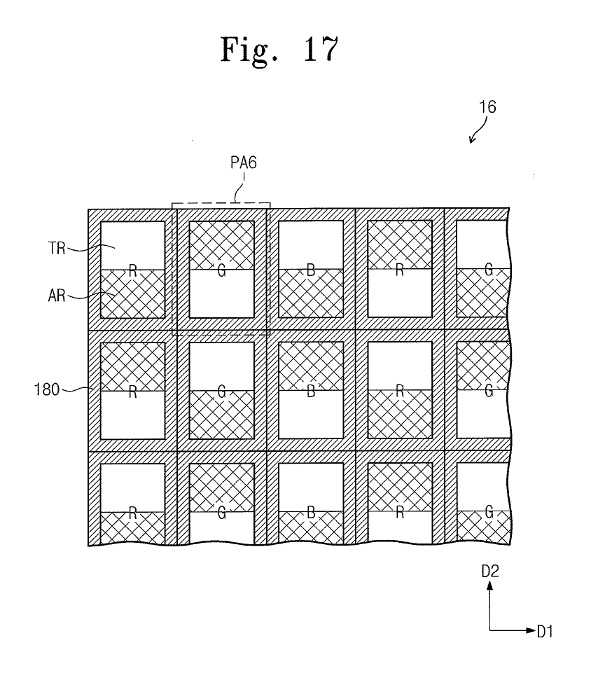

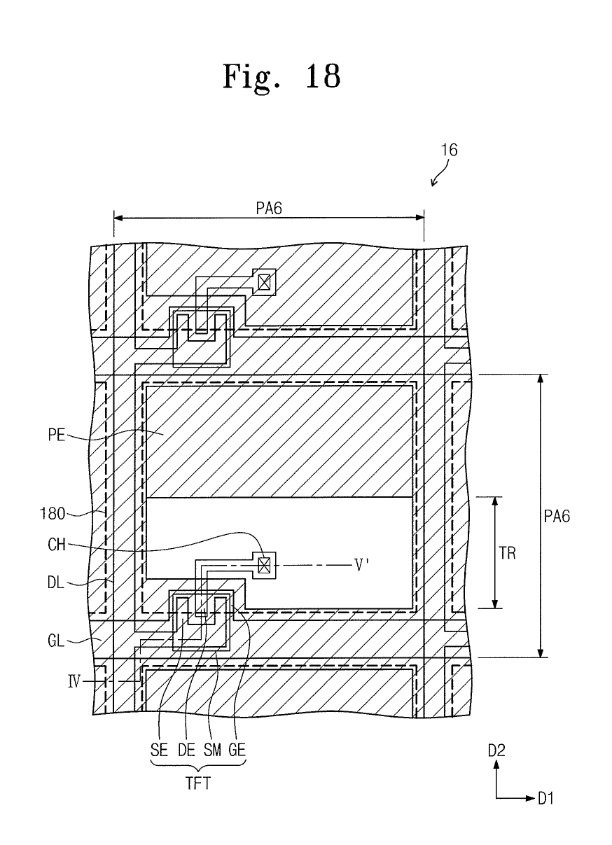

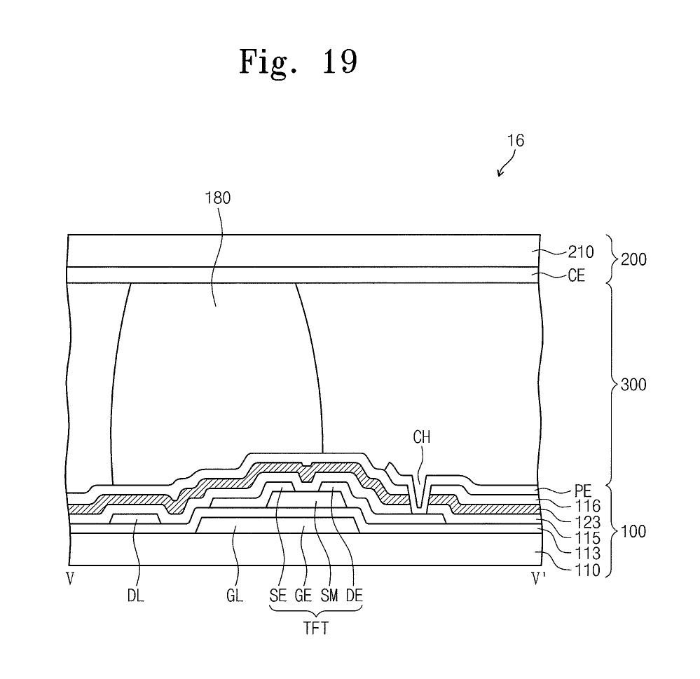

FIG. 16 is a perspective view showing the operation of a display apparatus according to the sixth embodiment of the present invention, FIG. 17 is a plan view showing a part of the display apparatus 16 according to the sixth embodiment of the present invention, FIG. 18 is a plan view showing pixels and walls of the display apparatus according to the sixth embodiment of the present invention, and FIG. 19 is a sectional view taken along line V-V′ of FIG. 18.

Referring to FIG. 16, the display apparatus 16 according to the sixth embodiment of the present invention outputs right-eye images RI and left-eye images LI in a row unit. The right-eye images RI and left-eye images LI are received in polarizing glasses 400. The user can recognize the 3-D image by receiving the right-eye images RI and left-eye images LI through eyes of the user. Similar to the display apparatus 10 shown in FIG. 1, the display apparatus 16 includes a first substrate 100, a second substrate 200 and a liquid crystal layer 300.

Referring to FIGS. 17 to 19, the display apparatus 16 according to the sixth embodiment of the present invention includes a plurality of pixels PA6. Each pixel PA6 includes a transmissive region TR to transmit the light and an absorption region AR to absorb the light. The absorption region AR is formed over the whole area of the pixel PA6 except for the transmissive region TR and a light absorption layer 123 is provided in the absorption region AR. The transmissive region TR of one pixel PA6 may cross the transmissive region TR of the adjacent pixel PA6. However, the arrangement of the transmissive region TR may not be limited to the above. For instance, the transmissive region TR of each pixel PA6 may be located in the same position as illustrated in the fourth embodiment.

Different from the fifth embodiment, walls 180 surround each pixel PA6. In detail, the walls 180 overlap with the data line DL in the second direction D2 and overlap with the gate line GL in the first direction D1. Therefore, internal cavities defined by the first substrate 100, the second substrate 200 and the walls may correspond to the pixels PA6 in one-to-one correspondence.

The pixels PA6 have the same structure except for the position of the transmissive regions TR. In addition, each pixel PA6 has a structure which is substantially the same as the structure of the pixel shown in FIGS. 2 and 3, so the same reference numerals will be assigned to the same elements of the pixels and the detailed description thereof will be omitted in order to avoid redundancy.

The cholesteric liquid crystal layer 300 is formed in the internal cavity defined in each pixel PA6 by the walls 180. Cholesteric liquid crystals have, for example, the levorotatory or the dextrorotatory according to the characteristic of the chiral dopant. If the cholesteric liquid crystals have the levorotatory, the cholesteric liquid crystals reflect the left-circular polarized light. In addition, if the cholesteric liquid crystals have the dextrorotatory, the cholesteric liquid crystals reflect the right-circular polarized light. The display apparatus 16 according to the sixth embodiment of the present invention divides the 2-D image into the left-eye image and the right-eye image by using the characteristics of the cholesteric liquid crystals.

In detail, the levorotatory cholesteric liquid crystal layer and the dextrorotatory cholesteric liquid crystal layer are alternately filled in the internal cavities, which are defined by the walls, in the unit of row. For instance, if the levorotatory cholesteric liquid crystal layer is provided in the first row, the dextrorotatory cholesteric liquid crystal layer is provided in the second row. In addition, the cholesteric liquid crystal layers may be aligned in such a manner that adjacent pixels PA6 present colors different from each other. For instance, if the red cholesteric liquid crystal layer is provided in one pixel PA6, the green or the blue cholesteric liquid crystal layer is provided in the adjacent pixel PA6.

The display apparatus 16 having the above structure operates as described below. For example, if the external light is incident into the second substrate 200, the cholesteric liquid crystal layer 300 reflects the light having the wavelength of red, green or blue according to the characteristics of the liquid crystals provided in each pixel PA6, and allows the remaining light to pass therethrough. At the same time, the right-polarized light and left-polarized light are reflected in the unit of row according to the characteristics of the liquid crystals provided in each pixel PA6.

Among the lights incident into the second substrate 200, the lights that have passed through the cholesteric liquid crystal layer 300 are absorbed in the light absorption layer 123 provided in the absorption region AR. Thus, the image is visible from the second substrate 200 due to the lights reflected from the cholesteric liquid crystal layer 300. Consequently, the image is the color image and the right-eye image RI and the left-eye image LI are alternately visible in the unit of row. The image is received in the left and right eyes of the user through the polarizing glasses 400, so that the user can recognize the 3-D image.

In contrast, although the light incident into the absorption region AR through the first substrate 100 is absorbed in the light absorption layer 123, the light, which is incident into the transmissive region TR and passes through the cholesteric liquid crystal layer 300, may pass through the second substrate 200, so that the user can recognize the object located at the rear of the first substrate 100 due to the light passing through the second substrate 200. Thus, the display apparatus 16 may operate as a color transparent reflective display apparatus.

Since the display apparatus according to the sixth embodiment displays the image by using the external light, the additional light source is not necessary, so that the thickness and the power consumption of the display apparatus can be reduced. In addition, the 2-D image is divided into the left-eye image and the right-eye image by using the characteristics of the cholesteric liquid crystals so that the additional polarizing plate used to divide the 2-D image is not necessary.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A display apparatus comprising:
a first substrate comprising a first insulating substrate, a plurality of pixels and a plurality of pixel electrodes disposed on the first insulating substrate corresponding to the pixels;
a second substrate comprising a second insulating substrate opposite to the first substrate and a common electrode disposed on the second insulating substrate;
a cholesteric liquid crystal layer interposed between the first and second substrates to reflect a first light of an external light incident to the cholesteric liquid crystal layer and to allow a second light having a wavelength different from a wavelength of the first light to pass therethrough; and
at least one light absorption layer to absorb the second light,
wherein at least one of the first and second substrate comprises at least one absorption region and at least one transmissive region formed thereon corresponding to the pixels, respectively, and the at least one light absorption layer is provided in the at least one absorption region respectively.

2. The display apparatus of claim 1, wherein the first substrate comprises the at least one absorption region and the at least one transmissive region formed thereon.

3. The display apparatus of claim 2, further comprising a transparent organic layer provided in each transmissive region.

4. The display apparatus of claim 1, wherein the first substrate comprises first absorption regions and first transmissive regions, the second substrate comprises second absorption regions and second transmissive regions, and the light absorption layers comprise first light absorption layers provided in the first absorption regions and the second light absorption layers provided in the second absorption regions.

5. The display apparatus of claim 4, wherein the first light absorption layers are spaced apart from the second light absorption layers when viewed in a plan view.

6. The display apparatus of claim 4, wherein the first absorption regions correspond to the second transmissive regions in one-to-one correspondence, and the second absorption regions correspond to the first transmissive regions in one-to-one correspondence.

7. The display apparatus of claim 4, further comprising a transparent organic layer provided in the first and second transmissive regions.

8. The display apparatus of claim 4, further comprising a common transmissive region wherein the first transmissive regions of the first substrate overlap with the second transmissive regions of the second substrate.

9. The display apparatus of claim 1, further comprising walls formed at edges of the pixels.

10. The display apparatus of claim 9, wherein the cholesteric liquid crystal layer comprises a red cholesteric liquid crystal layer, a green cholesteric liquid crystal layer, and a blue cholesteric liquid crystal layer, which are each provided in areas defined by the walls.

11. The display apparatus of claim 9, wherein the pixels are aligned in a form of a matrix, the cholesteric liquid crystal layer comprises a levorotatory liquid crystal layer having levorotary liquid crystal molecules and a dextrorotatory liquid crystal layer having dextrorotatory liquid crystal molecules, and the levorotatory liquid crystal layer and the dextrorotatory liquid crystal layer are alternately aligned in a unit of row in areas defined by the walls.

12. The display apparatus of claim 1, wherein the at least one transmissive region of the pixels are aligned in series.

13. The display apparatus of claim 1, wherein each transmissive region is aligned in a same line with the absorption area of an adjacent pixel when viewed in a plan view.

14. The display apparatus of claim 1, wherein each pixel comprises:
at least one gate line;
a data line crossing the gate line; and
at least one thin film transistor connected to the gate line, the data line and each pixel electrode.

15. The display apparatus of claim 14, further comprising a protective layer disposed on the thin film transistor, wherein the at least one light absorption layer is disposed on the protective layer in the pixels.

16. The display apparatus of claim 14, wherein each pixel comprises a first sub-pixel electrode disposed in the absorption region and a second sub-pixel electrode formed in the transmittive region, the gate line comprises a first gate line and a second gate line, and the thin film transistor comprises a first thin film transistor connected to the first gate line, the data line and the first sub-pixel electrode, and a second thin film transistor connected to the second gate line, the data line and the second sub-pixel electrode.

17. A display apparatus comprising:
a first substrate comprising a first insulating substrate including a plurality of pixels, wherein each of pixels includes an absorption region, a transmissive region, a pixel electrode, a gate line, and a data line crossing the gate line, and a thin film transistor connected to the gate line, wherein the absorption region is formed over a whole area of each of the pixels except for the transmissive region and wherein the transmissive region of one of the pixels crosses the transmissive region of an adjacent one of the pixels;
a second insulating layer disposed on the thin film transistor in each of the pixels;
a light absorption layer disposed on the second insulating layer and positioned corresponding to the absorption region in each of the pixels;
a protective layer disposed on the light absorption layer underneath the pixel electrodes which are connected to a drain electrode of the thin film transistor in each of the pixels;
a plurality of walls which surround each of the pixels and which overlap with the data line of each of the pixels in a first direction and overlap with the gate line of each of the pixels in a second direction opposite to the first direction;
a cholesteric liquid crystal layer formed in areas defined between the first and second substrates by the walls surrounding each of the pixels, wherein the cholesteric liquid crystal layer comprises a levorotatory liquid crystal layer having levorotary liquid crystal molecules and a dextrorotatory liquid crystal layer having dextrorotatory liquid crystal molecules, and the levorotatory liquid crystal layer and the dextrorotatory liquid crystal layer are alternately aligned in a unit of row in the areas defined by the walls; and
a second substrate comprising a second insulating substrate opposite to the first substrate and a common electrode disposed on the second insulating substrate,
and wherein the display apparatus is adapted such that a first light passing through the cholesteric liquid crystal is absorbed in the light absorption layer provided in the absorption region in each of the pixels and a second light is reflected from the cholesteric liquid crystal layer, thereby providing an image which is visible from a top surface of the second substrate.

18. The display apparatus of claim 17, wherein the second insulating layer and the protective layer each further include a contact hole formed therein which exposes a portion of the drain electrode, and wherein the pixel electrode is electrically connected to the drain electrode through the contact hole formed through the second insulating layer and the protective layer.

19. The display apparatus of claim 17, wherein the unit of row formed in the areas defined by the walls surrounding each of the pixels has a first row and a second row, wherein the levorotatory liquid crystal layer is provided in one of the first row or the second row of the unit of row, and wherein the dextrorotatory liquid crystal layer is provided in the other of the first row or the second row of the unit of row.

20. The display of claim 17, wherein each of the pixels represents one of a red color, green color or blue color.
